(19) United States
(12) Patent Application Publication
(10) Pub. No.: US 2023/0274732 A1
(43) Pub. Date: Aug. 31, 2023

(54) APPLICATIONS AND SERVICES FOR ENHANCED PROSODY INSTRUCTION

(71) Applicant: Microsoft Technology Licensing, LLC, Redmond, WA (US)

(72) Inventors: Michael THOLFSEN, Newcastle, WA (US); Alexander William DARROW, Seattle, WA (US); Paul Ronald RAY, Kirkland, WA (US); Kevin Chad LARSON, Seattle, WA (US)

(21) Appl. No.: 17/732,250

(22) Filed: Apr. 28, 2022

Related U.S. Application Data
(60) Provisional application No. 63/313,963, filed on Feb. 25, 2022.

(51) Int. Cl. G10L 15/18; G10L 25/51

(52) U.S. Cl. CPC G10L 15/1807; G10L 25/51

(57) ABSTRACT

Systems, methods, and software are disclosed herein that improve the instruction of prosody in the context of software applications and services. In various implementations, a service analyzes an audio recording of a user reading text aloud to determine the prosody of the reading. The service provides data to an application indicative the prosody, as well as a reference prosody for the text. The application may then display of a visualization of a comparison of the user prosody for the text to the reference prosody for the text for consumption by users, e.g., a teacher or the reader.

### RELATED APPLICATIONS

This application is related to - and claims the benefit of priority to - U.S. Provisional Pat. Application No. 63/313,963, entitled APPLICATIONS AND SERVICES FOR ENHANCED PROSODY INSTRUCTION, and filed on February 25^{th}, 2022, the contents of which are hereby incorporated by reference in their entirety.

### TECHNICAL FIELD

Aspects of the disclosure are related to the field of computer software applications and, in particular, to technology solutions for prosody instruction.

### BACKGROUND

In the field of linguistics, prosody relates to the ability to read written material with expression, thereby giving a complete and accurate picture of the material. Examples of prosody include reading aloud with the appropriate rhythm, tone, pitch, pauses, and stresses for the text. Beginning readers often struggle to read aloud with expression, and the result is a monotone reading style that fails to convey the mood or emotion of the text.

Classroom instruction is increasingly moving online, including reading instruction. Many software tools exist for creating groups, assigning tasks, and otherwise managing a classroom online, but the instruction of prosody remains the same as in the offline world. For example, a teacher may connect with a student on a video conference call and have the student read selected text aloud. Just as in the physical classroom, the teacher listens to the student read and provides feedback over the call.

Unfortunately, such online instruction with respect to prosody suffers from a lack of scale and other drawbacks. That is, the teacher can only listen to one student at a time and the students must wait their turn instead of proceeding at their own pace. In the case of classroom environments where many kids are in the same virtual classroom at the same time, shame or embarrassment may exacerbate the challenges of reading with prosody, just as in the offline equivalent, thereby rendering moot many of the advantages of online instruction.

### OVERVIEW

Technology is disclosed herein that improves the instruction of prosody in the context of software applications and services. In various implementations, a service analyzes an audio recording of a user reading text aloud to determine the prosody of the reading. The service provides data to an application indicative the prosody, as well as a reference prosody for the text. The application may then display of a visualization of a comparison of the user prosody for the text to the reference prosody for the text for consumption by users, e.g., a teacher or the reader.

This Overview is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational example in an implementation.

FIG. 2 illustrates a prosody process in an implementation.

FIG. 3 illustrates another operational environment in an implementation.

FIG. 4 illustrates an operational scenario in an implementation.

FIG. 5 illustrates another operational scenario in an implementation.

FIG. 6 illustrates yet another operational scenario in an implementation.

FIG. 7 illustrates a user experience in an implementation.

FIG. 8 illustrates another user experience in an implementation.

FIG. 9 illustrates a computing system suitable for implementing the various operational environments, architectures, processes, scenarios, and sequences discussed below with respect to the other Figures.

### DETAILED DESCRIPTION

Various implementations disclosed herein related to new technology that makes it easier for students to learn to read aloud with the appropriate rhythm, tone, pitch, pauses, and stresses for a text, while also improving the teaching experience. The technical advances may be employed in the context of any number of applications and computing devices including - but not limited to - video conferencing platforms, dedicated instructional software, and other such collaboration tools.

In one implementation, a software program on a computing device directs the device to capture an audio recording of a user reading text aloud. The text may be, for example, a sentence or paragraph selected from a library of available texts by either the student or instructor. The software further directs the device to send the audio recording to a remote service to analyze the user prosody of the reading of the text aloud. Alternatively, the software could analyze the user prosody locally.

The remote service receives the audio recording and employs a speech-to-text engine to convert the audio to a text representation of the user’s speech. The text representation is also annotated by a prosody engine with indications of the user’s prosody such as pitch, duration, and volume. The service replies to the user computing device with data indicative of at least the user’s prosody, if not also the entire text representation of the user’s speech. In some cases, the remote service may also provide the reference prosody, although the reference prosody could be pre-provisioned with the selected text. As mentioned, the speech and prosody engines could also be implemented locally on the user’s computing device if so desired. Examples of the data include specific values that represent the various elements of prosody on an appropriate scale.

The computing device receives the user prosody data from the remote service and generates a visualization of a comparison of the user prosody relative to the reference prosody. The comparison may be displayed in, for example, a user interface to the software program in such a manner that a user can see how well the reader tracked a reference reading of the text. Examples of the visualization include linear graphs that track a display of the text in-time such that the graphs can be compared to each other with easy reference to the text.

In a brief illustration, the words of the text would frame the horizontal axis of a graph, while the vertical axis would represent a prosody scale corresponding to a prosody value used to represent the user prosody and the reference prosody. A first line graph would then represent the user prosody and would be generated based on the values provided for the user prosody in association with the words of the text. A second line graph would represent the reference prosody in the same manner. The two graphs could be displayed in such a manner to allow an easy comparison of the user’s prosody to the reference prosody, such as by overlaying the user prosody on top of the reference prosody. The visualization of prosody may also include various symbols representative of the user prosody values at one or more points along the linear graph. Examples of such symbols include a symbol indicative of when a student stopped reading, a symbol indicative of when the student expressed punctuation incorrectly, and a symbol indicative of when the student placed stress on an incorrect syllable of a word.

The user experiences disclosed herein may be provided in the context of the reader’s experience, an instructor’s experience, or both. For example, a library of texts could be available for consideration and selection by the teacher, in which case the text would be provided to and presented in the the student’s environment. Conversely, the student could be provided with the ability to select a preferred text from the library. Likewise, the visualization of the comparison of prosody could be display in the teacher’s user interface, as well as the student’s user interface.

Various technical effects may be appreciated from the present discussion, including the ability capture and analyze a reader’s prosody, while providing the analysis to both the reader and to a teacher. Such an arrangement allows for prosody instruction at-scale and remotely. New visualizations for both teachers and students automatically pinpoint key areas where prosody is wrong or could be improved. In addition, the technology disclosed herein includes new dashboards the provide visualizations of prosody comparison and insights that allow a teacher to analyze patterns of prosody across a student or a class.

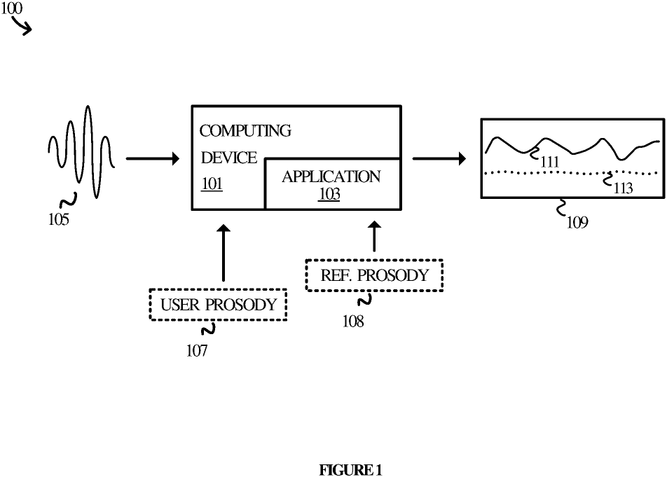

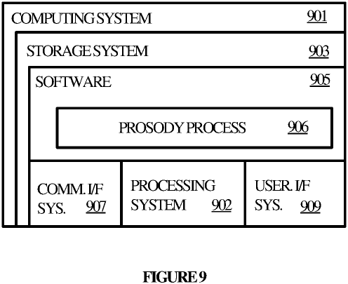

FIG. 1 illustrates an operational environment 100 in an implementation with respect to computing device 101. Computing device 101 includes one or more software applications, of which application 103 is representative, capable of providing an enhanced user experience with respect to prosody instruction. Examples of computing device 101 include personal computers, tablet computers, mobile phones, and any other suitable devices, of which computing device 901 in FIG. 9 is broadly representative.

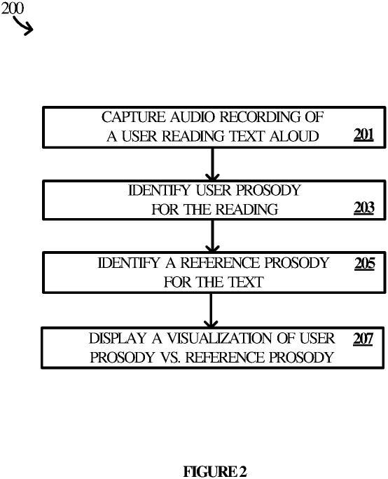

Application 103 is representative of any software application capable of employing process 200, illustrated in FIG. 2, to enhance experience of prosody instruction. Process 200 may be implemented in program instructions in the context of any of the software applications, modules, components, or other such elements of one or more computing devices (e.g., computing device 101). The program instructions direct the computing device(s) to operate as follows, referred to in the singular for the sake of clarity.

In operation, the computing device captures an audio recording of a user reading a selection of text aloud (step 201). For example, the text may be displayed on a screen of the computing device in the context of a user interface to a software application. A microphone of the device captures the audible sounds produced by the user which are converted by other sub-systems of the computing device into the audio recording. In some scenarios, the user interface is a screen or module of a video conferencing application in the context of which the user is conversing with or otherwise connected to one or more other people such as an instructor (teacher), students, and the like. The text may even be provided by the instructor and/or provided automatically by the software. In some implementations, the user interface is merely an audible user interface (screenless) such as an intelligent voice assistant.

Next, the computing device identifies a prosody of the reading by the user (step 203). The device may analyze the prosody itself, or the device may obtain the prosody analysis from a remote service. The prosody analysis generates data indicative of one or more of the rhythm, tone, pitch, pauses, and stresses contained or represented in the audio recording of the user’s reading. That is, the characteristics of the sound produced by the reader are represented in the digital signals captured by the audio recording. The prosody analysis processes the audio data to identify those characteristics and to describe them in terms of prosody qualities.

The computing device also identifies a reference prosody for the selected text (step 205). The reference prosody is obtained from a remote service, although in some scenarios the computing device may generate the reference prosody itself. In most cases, the same remote service that provides the user prosody data also provides the reference prosody data. The reference prosody data indicates one or more of the rhythm, tone, pitch, pauses, and stresses contained or represented in a reference audio recording of a reference reading of the selected text. For example, an instructor may read the selected text and the prosody of the instructor’s reading may be considered the reference prosody. In other scenarios, a selected text may come with prosody data generated by a third-party reading of the text. In any case, the reference prosody may be understood as a standard prosody against which to evaluate the user (student) prosody expressed in the audio recording.

The user prosody may be compared to the reference prosody to determine differences between the two. The comparison may be performed by a remote service or could be performed locally by the computing device. The computing device displays a visualization of the comparison in the user interface for the user to consume and understand (step 207). Users obtain immediate feedback from the visualization, allowing them to improve their reading prosody in real-time and potentially independent of the instructor.

Referring back to FIG. 1, operational environment 100 includes a brief example of process 200 as employed by application 103 on computing device 101. In operation, a user reads a portion of selected text aloud, which produces an audible signal 105 captured and recorded by application 103 on computing device 101. Application 103 identifies a user prosody 107 for the reading, as well as a reference prosody 108 for the selected text. As mentioned, the user prosody may be identified by application 103 itself or obtained from an external service or another application on computing device 101. Likewise, application 103 may generate reference prosody 108 itself or obtain it from another application or service.

Application then identifies differences between the user prosody and the reference prosody and surfaces a visual representation of them in user interface 109 to application 103. User interface 109 may be display on a display screen of computing device 101, for example, or any suitable device. In this scenario, the reference prosody is visualized by line 111, which is intended to represent at least one or more aspects of the reference prosody identified for the selected text. The user prosody is then visualized by line 113 which corresponds in time to line 111. Users can thus see how their prosody compares to the reference prosody in real-time. In this example, the user is speaking with less prosody than the standard or ideal prosody.

User interface 109 may be displayed in the context of the user experience of the student, the user experience of the instructor, or both. Such an arrangement allows multiple students to learn in real-time and in parallel, increasing the scale at which the instructor can teach students prosody.

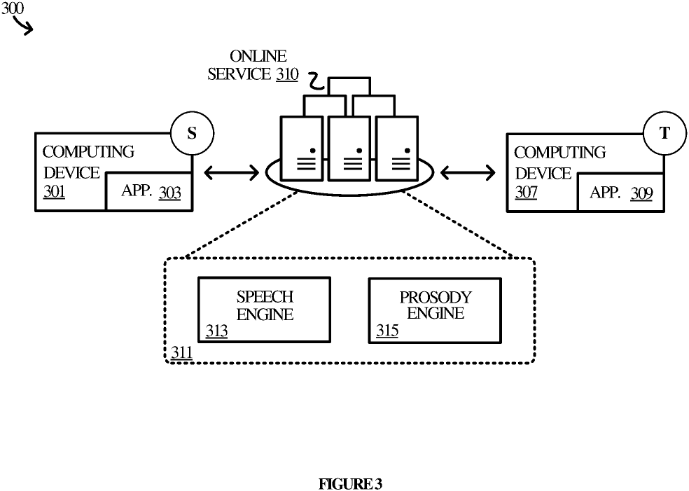

FIG. 3 illustrates computing environment 300 in another implementation. Computing environment 300 includes computing device 301, computing device 307, and online service 310. Computing device 301 includes application 303, and computing device 307 includes application 309. Online service 310 includes a sub-service 311, which itself includes speech engine 313 and prosody engine 315.

Computing device 301 is representative of any computer capable of hosting an application (or applications) capable of connecting to and communicating with online services. Examples of computing device 301 include desktop computers, laptop computers, tablet computers, mobile phones, gaming systems, and any other types of devices, of which computing device 901 is representative.

Application 303 is representative of any application capable of running on computing device 301 and interfacing with an online service. Examples of application 303 include - but are not limited to - voice and video conferencing applications, chat applications, collaboration applications, communication applications, and the like. Application 303 may be a stand-alone application or may be integrated in the context of another application, an operating system, or other such environment. Application 303 may also be a natively installed and executed applications, a browser-based application that runs in the context of a web browser, a streaming (or streamed) application, a mobile application, or any other type of application.

Computing device 307 is representative of any computer capable of hosting an application (or applications) capable of connecting to and communicating with online services. Examples of computing device 307 include desktop computers, laptop computers, tablet computers, mobile phones, gaming systems, and any other types of devices, of which computing device 901 is representative.

Application 309 is representative of any application capable of running on computing device 307 and interfacing with an online service. Examples of application 309 include – but are not limited to – voice and video conferencing applications, chat applications, collaboration applications, communication applications, and the like. Application 309 may be a stand-alone application or may be integrated in the context of another application, an operating system, or other such environment. Application 309 may also be a natively installed and executed applications, a browser-based application that runs in the context of a web browser, a streaming (or streamed) application, a mobile application or any other type of application.

Online service 310, which is optional, provides one or more computing and/or communication services to end points such as computing devices 301 and 307. Examples of such services include – but are not limited to – voice and video conferencing services, collaboration services, file storage services, and other application services. In some examples, online service 310 may provide a suite of applications and services with respect to a variety of computing workloads such as office productivity tasks, email, chat, voice and video, and so on. Online service 310 employs one or more server computers co-located or distributed across one or more data centers connected to computing devices 301 and 307. Examples of such servers include web servers, application servers, virtual or physical (bare metal) servers, or any combination or variation thereof, of which computing device 901 in FIG. 9 is broadly representative. Online service 310 may communicate with computing devices 301 and 307 via one or more internets, intranets, the Internet, wired and wireless networks, local area networks (LANs), wide area networks (WANs), and any other type of network or combination thereof.

Online service 310 also includes a sub-service 311 that allows online service 310 to provide prosody analysis, features, and functionality in the context of the various computing and communication services that it also provides. For example, online service 310 can provide prosody assistance in the context of a video call or conference between an instructor and one or more students, as well as in the context of independent student sessions.

Sub-service 311 includes a speech engine 313 and a prosody engine 315. Speech engine 313 provides speech analytics capabilities to translate speech into text. Prosody engine 315 is capable of analyzing text to determine a reference prosody for the text. Sub-service 311 may be implemented on one or more server computers, of which computing device 901 in FIG. 9 is broadly representative. While contemplated as a sub-service of online service 310, it may be appreciated that sub-service 311 could also be implemented as a separate service independent from online service 310. Similarly, speech engine 313 and prosody engine 315 could each be implemented independent of each other. In still other variations, speech engine 313 may be implemented on computing device 301 and/or computing device 307. Prosody engine 315 could also be implemented on computing device 301 and/or computing device 307.

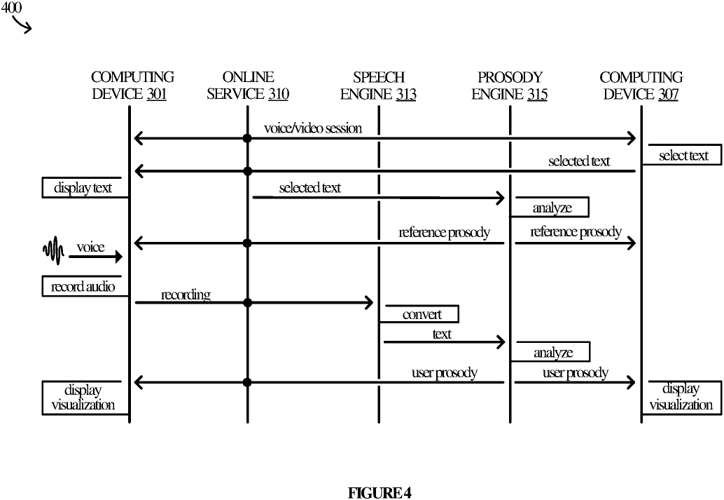

FIG. 4 illustrates an operational scenario 400 with respect to the elements of FIG. 3. In operation, two users operate computing devices 301 and 307 respectively. The first user associated with computing device 301 is assumed for exemplary purposes to be a student, while the second user associated with the computing device 307 is assumed to be a teacher. The two connect via a video conference session through online service 310. It is assumed for exemplary purposes that the session continues for the duration of the example illustrated in FIG. 4.

It is further assumed for exemplary purposes that the teacher operating computing device 307 selects all or a portion of reading material (text) for the student to read. The text may be selected in any of a variety of ways. For example, the selection may be made from a menu or library of available materials provided in the user interface to application 309. Alternatively, the teacher may copy and paste the text from an available resource (e.g., a website or a document) into a reading module within the user interface. In any case, the selected text is communicated to the student via online service 310 and is displayed by computing device 301 in a user interface to application 303 for the student to consume and read.

The selected text may also be sent by online service to prosody engine 315. Alternatively, the text may be sent to prosody engine 315 by application 309 on computing device 307 and/or by application 303 on computing device 301. Prosody engine 315 receives the text and processes it to identify a reference prosody for the text. Prosody engine 315 then sends the reference prosody to one or both of applications 303 and 309 on computing devices 301 and 307 respectively.

The student may then proceed to read the selected text aloud. Computing device 301 captures the sound produced by the student when reading the text and records the resulting audio data. Application 303 sends the audio recording to speech engine 313 to convert to text. Speech engine 313 receives the audio recording and converts the recorded speech to text. Speech engine 313 then sends the text to prosody engine 315.

Prosody engine 315 receives the text of the user’s reading and analysis it for its prosody. Prosody engine 315 sends prosody data to application 303 and application 309 that is indicative of the user prosody resulting from its analysis. Application 303 on computing device 301 receives the prosody data and produces a visualization of the user’s prosody relative to the reference prosody. Application 309 also receives the prosody data and is similarly able to display a comparison of the user’s prosody to the reference prosody. The resulting visualizations allow both the student and the teacher to see a concrete comparison of the student’s ability to read with prosody relative to a standard prosody for the selected text.

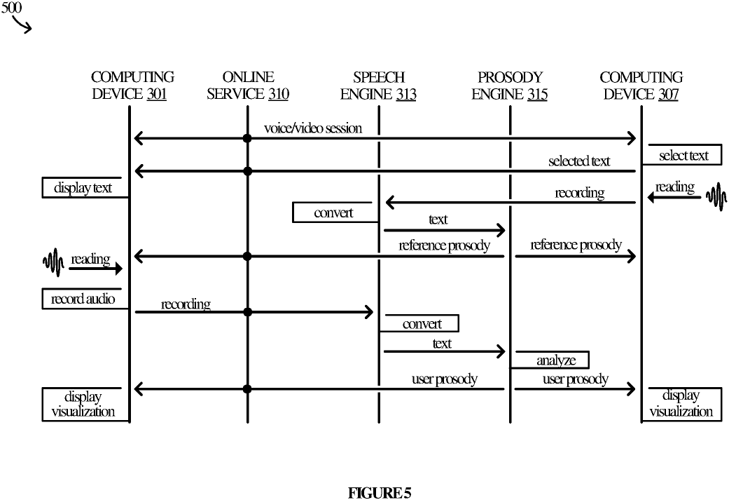

FIG. 5 illustrates another operational scenario 500 in an implementation, also with respect to the elements of FIG. 3. The operational scenario in FIG. 5 is largely the same as that illustrated in FIG. 4, except that the reference prosody is not derived from the selected text, but rather from the teacher’s reading of the selected text.

In operation, the teacher operating computing device 307 selects all or a portion of reading material (text) for the student to read. The text may be selected in any of a variety of ways. For example, the selection may be made from a menu or library of available materials provided in the user interface to application 309. Alternatively, the teacher may copy and paste the text from an available resource (e.g., a website or a document) into a reading module within the user interface. In any case, the selected text is communicated to the student via online service 310 and is displayed by computing device 301 in a user interface to application 303 for the student to consume and read.

The teacher proceeds to read the selected text to give the student an example of the appropriate prosody for the text. Application 309 on computing device 307 records the audio and sends the recording to speech engine 313. Speech engine 313 converts the audio to text and analytics data and sends the text to prosody engine 315 for analysis. Prosody engine 315 analyzes the text and analytics data to identify a reference prosody for the selected text. Prosody engine 315 then sends the reference prosody to one or both of applications 303 and 309 on computing devices 301 and 307 respectively.

The student may then proceed to read the selected text aloud. Computing device 301 captures the sound produced by the student when reading the text and records the resulting audio data. Application 303 sends the audio recording to speech engine 313 to convert to text. Speech engine 313 receives the audio recording and converts the recorded speech to text. Speech engine 313 then sends the text to prosody engine 315.

Prosody engine 315 receives the text of the user’s reading and analysis it for its prosody. Prosody engine 315 sends prosody data to application 303 and application 309 that is indicative of the user prosody resulting from its analysis. Application 303 on computing device 301 receives the prosody data and produces a visualization of the user’s prosody relative to the reference prosody. Application 309 also receives the prosody data and is similarly able to display a comparison of the user’s prosody to the reference prosody. The resulting visualizations allow both the student and the teacher to see a concrete comparison of the student’s ability to read with prosody relative to a standard prosody for the selected text.

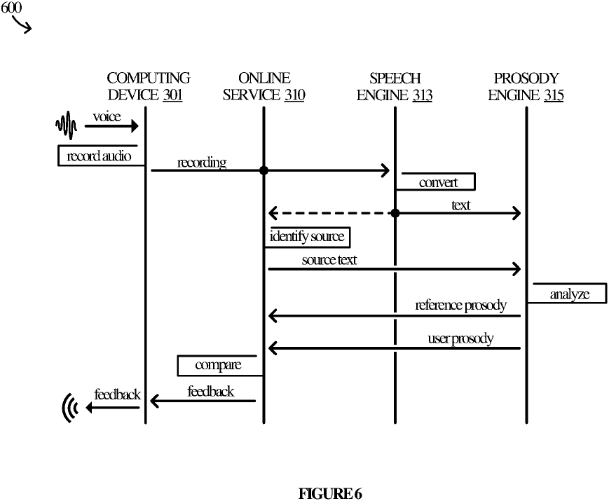

FIG. 6 illustrates another operational scenario 600 with respect to the elements of FIG. 3 that is similar in some respects to FIG. 4 and FIG. 5, but different in others. In FIG. 6, the student operating computing device 301 can obtain prosody instruction without having to read text from a screen, but rather can receive prosody instruction autonomously from an intelligent voice assistant.

In operation, a first user (e.g., a student), operating computing device 301 reads material aloud. An intelligent voice assistant or other such application on computing device 301 records the audio and sends the recording to speech engine 313. Speech engine 313 converts the speech to text and sends the text to prosody engine 315 and optionally to online service 310.

In some scenarios, online service 310 identifies the source of the text from the text provided to it by speech engine 313. For example, online service 310 may search a library or database of reading materials to find the closest match to the material read by the student as represented in the text. Online service 310 may then send the source text to prosody engine 315.

Prosody engine 315 receives the source text and processes it to identify a reference prosody. In addition, prosody engine 315 analyzes the user text provided by speech engine 313 to identify a user prosody for the reading. Prosody engine 315 sends the reference prosody and the user prosody to online service 310. Online service 310 may then compare the user prosody and the reference prosody and provides data indicative of the results of the comparison to computing device 301. The intelligence voice assistant on computing device 301 can then audibly guide readers with respect to the prosody of their reading.

In some implementations, online service 310 need not identify a source of the text. Rather, a reference prosody could be provided by away of another reader, co-located with the first reader, reading the same text. An audio recording of the second reader’s reading can also be provided to speech engine 313, and the resulting text provided to prosody engine 315. Prosody engine can then provide both the prosody information for the first reader and the prosody information for the second reader (assumed to be a reference prosody) to online service 310. Online service 310 can analyze the differences and provide feedback information to computing device 310 to be output audibly by the intelligent voice assistant.

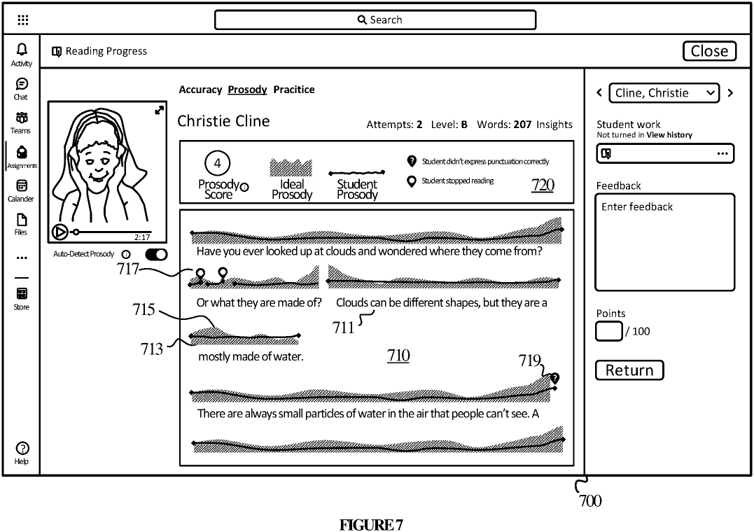

FIG. 7 illustrates a user experience 700 in an implementation that is representative of the user experiences discussed above. In this example, user experience 700 is a screen shot of a user interface generated and displayed by an application on a computing device, examples of which include Microsoft® Teams. The user interface includes two sections represented by section 710 and section 720. Section 720 provides a key for understanding the symbols and other visualizations represented in section 710. For example, section 710 includes the text 711 being read by the user, a visualization 713 of the reference prosody for the text, and a visualization 715 of the user prosody for the text. Section 710 also includes a visualization 717 of a symbol indicative of when a student stopped reading, as well as a visualization 719 of a symbol indicative of when the student expressed punctuation incorrectly. Still another example (not shown) includes a visualization of when a student stresses the wrong syllable of a word (e.g., stressing the first syllable in college, pronouncing it COLLege, rather than stressing the second syllable and pronouncing it collEGE).

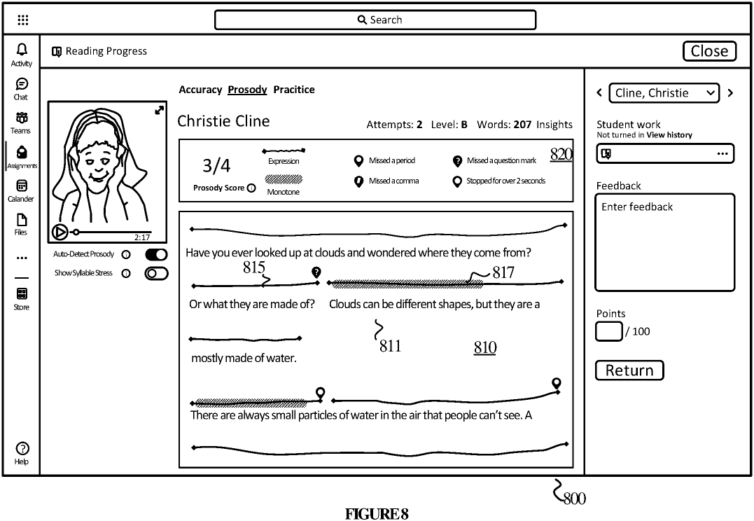

FIG. 8 illustrates a similar user experience 800 in another implementation that is also representative of the user experiences discussed above. It may be appreciated that the concepts illustrated in FIG. 8 could be combined with those illustrated in FIG. 7. In this example, user experience 800 is again a screen shot of a user interface generated and displayed by an application on a computing device. The user interface includes two sections represented by section 810 and section 820. Section 820 provides a key for understanding the symbols and other visualizations represented in section 810. For example, section 810 includes the text 811 being read by the user and a visualization 815 of the user prosody for the text. Section 810 also includes a visualization 817 of when a student is reading in a monotone voice.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements prosody process 906, which is representative of the processes discussed with respect to the preceding Figures, such as process 200. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including multipoint prosody process 906) may be implemented in program instructions and among other functions may, when executed by processing system 902, direct processing system 902 to operate as described with respect to the various operational scenarios, sequences, and processes illustrated herein. For example, software 905 may include program instructions for implementing a prosody process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support prosody analysis and visualizations in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of video conferencing solutions and productivity applications, they apply as well to other contexts such as gaming applications, virtual and augmented reality applications, business applications, and other types of software applications. Likewise, the concepts apply not just to video conferencing content and environments but to other types of content and environments such as productivity applications, gaming applications, and the like.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
capture an audio recording of a user reading text aloud;
send the audio recording to a remote service to analyze user prosody of the reading of the text aloud;
receive data from the remote service indicative of at least the user prosody for the text and a reference prosody for the text; and
enable display, in a user interface, of a visualization of a comparison of the user prosody for the text to the reference prosody for the text.

2. The computing apparatus of claim 1 wherein the data includes user prosody values indicative of the user prosody for the text and reference prosody values indicative of the reference prosody for the text, and wherein the visualization of the comparison of the user prosody for the text to the reference prosody for the text comprises a visual representation of at least a portion of the user prosody values, and a visual representation of at least a portion of the reference prosody values.

3. The computing apparatus of claim 2 wherein the visual representation of the user prosody values comprises a linear graph corresponding in time to words in the text, and the visual representation of the reference prosody values comprises another linear graph corresponding in time to the words in the text.

4. The computing apparatus of claim 3 wherein the program instructions further direct the computing apparatus to enable display of one or more symbols representative of one or more of the user prosody values at one or more points along the linear graph.

5. The computing apparatus of claim 4 wherein the one or more symbols include a symbol indicative of when a student stopped reading, a symbol indicative of when the student expressed punctuation incorrectly, and a symbol indicative of when a student stressed a syllable incorrectly.

6. The computing apparatus of claim 1 wherein the program instructions further direct the computing apparatus to enable display of a library of texts in the user interface.

7. The computing apparatus of claim 6 wherein the program instructions further direct the computing apparatus to receive a selection of the text through the user interface.

8. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
upload text to a remote service that performs a prosody analysis of audio recordings made of users reading aloud;
receive data from the remote service indicative of at least a reference prosody for the text, and a user prosody for the text associated with an audio recording of a user reading the text aloud; and
enable display, in a user interface, of a visualization of a comparison of the user prosody for the text to the reference prosody for the text.

9. The computing apparatus of claim 1 wherein the program instructions further direct the computing apparatus to enable display of a library of texts in the user interface, and to receive a selection of the text through the user interface.

10. The computing apparatus of claim 9 wherein the data includes user prosody values indicative of the user prosody for the text and reference prosody values indicative of the reference prosody for the text, and wherein the visualization of the comparison of the user prosody for the text to the reference prosody for the text comprises a visual representation of at least a portion of the user prosody values, and a visual representation of at least a portion of the reference prosody values.

11. The computing apparatus of claim 10 wherein the visual representation of the user prosody values comprises a linear graph corresponding in time to words in the text, and the visual representation of the reference prosody values comprises another linear graph corresponding in time to the words in the text.

12. The computing apparatus of claim 11 wherein the program instructions further direct the computing apparatus to enable display of one or more symbols representative of one or more of the user prosody values at one or more points along the linear graph.

13. The computing apparatus of claim 12 wherein the one or more symbols include a symbol indicative of when a student stopped reading, a symbol indicative of when the student expressed punctuation incorrectly, and a symbol indicative of when a student stressed a syllable incorrectly.

14. A method for analyzing reading prosody, the method comprising:
in a server computer, receiving from a remote computing device an audio recording of a user reading a passage of text aloud;
in the server computer, analyzing the audio recording to identify a prosody of the reading of the passage of text by the user;
in the server computer, performing a comparison of the prosody to a reference prosody associated with a reference reading of the passage of text; and
in the server computer, sending data to the remote computing device indicative of results of the comparison of the prosody to the reference prosody.

15. The method of claim 14 further comprising:
in a user computer, capturing the audio recording of the user reading text aloud;
in the user computer, sending the audio recording to a remote service hosted on the server computer to analyze user prosody of the reading of the text aloud;
in the user computer, receiving the data from the remote service, wherein the data comprises a user prosody for the text and a reference prosody for the text; and
in the user computer, displaying in a user interface a visualization of a comparison of the user prosody for the text to the reference prosody for the text.

16. The method of claim 15 wherein the data includes user prosody values indicative of the user prosody for the text and reference prosody values indicative of the reference prosody for the text, and wherein the visualization of the comparison of the user prosody for the text to the reference prosody for the text comprises a visual representation of at least a portion of the user prosody values, and a visual representation of at least a portion of the reference prosody values.

17. The method of claim 16 wherein the visual representation of the user prosody values comprises a linear graph corresponding in time to words in the text, and the visual representation of the reference prosody values comprises another linear graph corresponding in time to the words in the text.

18. The method of claim 17 wherein the method further comprises displaying one or more symbols representative of one or more of the user prosody values at one or more points along the linear graph, wherein the one or more symbols include a symbol indicative of when a student stopped reading, a symbol indicative of when the student expressed punctuation incorrectly, and a symbol indicative of when a student stressed a syllable incorrectly.

19. The method of claim 15 further comprising displaying a library of texts in the user interface.

20. The method of claim 19 further comprising receiving a selection of the text through the user interface.
